(19) United States
(12) Patent Application Publication
(10) Pub. No.: US 2001/0032178 A1
(43) Pub. Date: Oct. 18, 2001

(54) Network based loan approval and document origination system

(76) Inventors: Lloyd Adams, Houston, TX (US); Merlin Reynolds, Houston, TX (US)

Correspondence Address: OSTROLENK FABER GERB & SOFFEN, 1180 AVENUE OF THE AMERICAS, NEW YORK, NY, 100368403

(21) Appl. No.: 09/765,137

(22) Filed: Jan. 18, 2001

Related U.S. Application Data
(60) Provisional application No. 60/198,502, filed on Apr. 18, 2000.

(51) Int. Cl. G06F 17/60

(52) U.S. Cl. 705/38; 705/35; 705/39; 705/42

(57) ABSTRACT

A customer sends loan information through the Internet to a loan approval system mainframe of a bank. The information is entered into a blank load form displayed on a web site hosted by the loan approval system computer. The loan approval system mainframe produces a loan application and sends the loan application to a credit bureau. The credit bureau determines whether the customer should receive the loan. If the customer is to receive the loan, the loan approval system computer sends the loan application to a loan document creation server coupled to a forms database. The loan document creation server sends the appropriate loan documents and/or check to the customer either physically or electronically. In one embodiment, acceptance of the terms of the loan in the loan documents occurs when the customer cashes the check.

### CROSS-REFERENCE TO RELATED APPLICATIONS

This application claims priority to provisional application Ser. No. 60/198,502 filed Apr. 18, 2000.

### BACKGROUND OF THE INVENTION

1. Field of the Invention

The invention relates to a network based loan origination system and, more particularly, to a loan origination system which efficiently processes a customer's loan application request and quickly produces loan documents associated with an approved loan request.

2. Description of the Related Art

When a customer desires to apply for a loan from a bank or other financial institution (hereinafter collectively referred to as “bank”), the customer typically fills out a loan application that is reviewed and processed by the bank. A single bank will typically service and process loan applications from many customers in many locations (e.g., branches). However, as the review and approval is the same for most loan applications, the review and approval is generally consolidated into one or a few locations of the bank.

Referring to FIG. 1, there is shown a typical prior art loan origination system. In a conventional loan origination system 40, a customer 50 who desires to receive a loan from a bank 52, visits a branch 54 of bank 52. At branch 54, customer 50 conveys to a branch employee 56 the loan information 53 necessary to process the loan application. Loan information 53 includes all the information necessary to fill out an application for a loan including, for example, the customer's name, address, income, social security number, desired amount of loan, loan term, monthly expenses, employment, etc.

Branch employee 56 manually enters loan information 53 into a branch computer 58 that is coupled to a forms database 60. Branch employee 56 control branch computer 58 to merge the loan information 53 into the appropriate form in forms database 60. In response to loan information 53, and the inputs from branch employee 56, and the appropriate form in forms database 60, branch computer 58 produces and prints out a loan application 64. Alternatively, in some prior art systems, branch employee 56 manually retrieves a paper loan form from a loan file 51 and manually drafts loan application 64. Once loan application 64 is completed, branch employee 56 faxes loan application 64 through a fax machine 66 to a back-office fax machine 68 located at a back-office 70 of bank 52.

At back office 70, a back-office employee 72 retrieves loan application 64 from back-office fax machine 68. In some systems, loan application 64 is automatically scanned as an image into a Document Imaging/Archive system (not shown) which stores the information in loan application 64. Thereafter, back-office employee 72 may enter additional information not available on loan application 64. The customer's information from loan application 64 is then entered into a loan approval system mainframe 74 either manually by back-office employee 72 or automatically through an electronic interface. If the loan is approved, loan approval system mainframe 74 refers to a loan origination system forms database 62 and eventually produces loan documents 76 associated with loan application 64. Loan documents 76 contain the terms and conditions of the loan that the bank 52 is willing to extend to customer 50.

A hard copy of loan documents 76 are retrieved by back-office employee 72 and presented to customer 50 for signature or mailed to customer 50 for review and signature. Customer 50 reviews loan documents 76 and if he/she agrees to the terms and conditions, again goes to branch 54 to execute loan documents 76 to bank 52 or mails the signed loan documents back to bank 52. Signed loan documents 76 are sent back to back-office 70 by branch employee 56. Loan origination system 40 is completed by back-office employee 72 adding a loan application or “booking” flag into loan application 64. Loan information 53 in then typically automatically updated that night into a loan accounting system 78 that tracks the new receivable account produced by the loan.

This prior art arrangement is undesirable in many ways. Two bank employees (branch employee 56 and back-office employee 72) are needed to perform the same data entry task (that of entering the customer's information into a computer). In some instances, branch employee 56 is actually writing loan application 64 by hand which leads to errors when back-office employee 72 reads loan application 64. Further, in order to perform the data entry task, two employees must be trained to interface with generally complex loan origination systems. Finally, bank 52 incurs labor costs when branch employee 56 spends time manually faxing loan documents 76 to back office 70 and back-office employee 72 spends time manually entering the loan information into booking system 78.

Additionally, as shown in FIG. 1, a typical bank 52 will have many branch offices 54. In each of these offices, branch employee 56 is given the responsibility to ensure that the correct loan form is retrieved from forms database 60 or loan file 51. This is problematic in that it requires that branch employee 56 know which form to retrieve and that loan file 51 and forms database 60 do not include obsolete forms. Moreover, whenever loan forms change, a representative of bank 52 must visit or otherwise contact every branch 54 to update loan file 51 and forms database 60. Clearly, this is a very costly task.

Thus, there is a need in the art for a loan origination system which is more efficient and less costly than prior art loan origination systems. Such a loan origination system should be able to ensure that the correct loan form is used in loan applications and to avoid the need for a bank representative to visit every bank branch when loan forms or the loan origination system is updated.

### SUMMARY OF THE INVENTION

In the system and method of the present invention, a customer enters and then sends loan information through the Internet to a loan approval system mainframe of a bank. Alternatively, a back-office employee sends the loan information to the loan approval system mainframe through the Internet. The loan approval system mainframe produces an internal electronic loan application data record and sends the loan application electronically to a credit approval agency such as a credit bureau. The bank determines whether the customer should receive the loan based upon an electronically transmitted report or loan decision indicator received real-time from the credit bureau. If the customer is to receive the loan, the loan approval system mainframe sends the loan application to a loan document creation server. The loan document creation server merges the loan information with a forms database to create a complete loan document package including an approval letter, a loan promissory note, additional attachments if needed, and, in some embodiments, a negotiable check.

The loan document creation server further sends the appropriate loan documents and a check in the amount of the loan to the customer. In one embodiment, acceptance of the terms of the loan in the loan documents occurs when the customer cashes the check. In another embodiment, the funds are automatically credited to the customer's demand deposit, investment, or savings account at a financial institution of choice.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown.

FIG. 1 is a diagram illustrating a loan origination system of the prior art.

FIG. 2 is a diagram illustrating a loan origination system in accordance with the invention.

FIG. 3 is a diagram illustrating the components of a loan approval system mainframe used in accordance with the invention.

### DETAILED DESCRIPTION OF THE PREFERRED EMBODIMENT

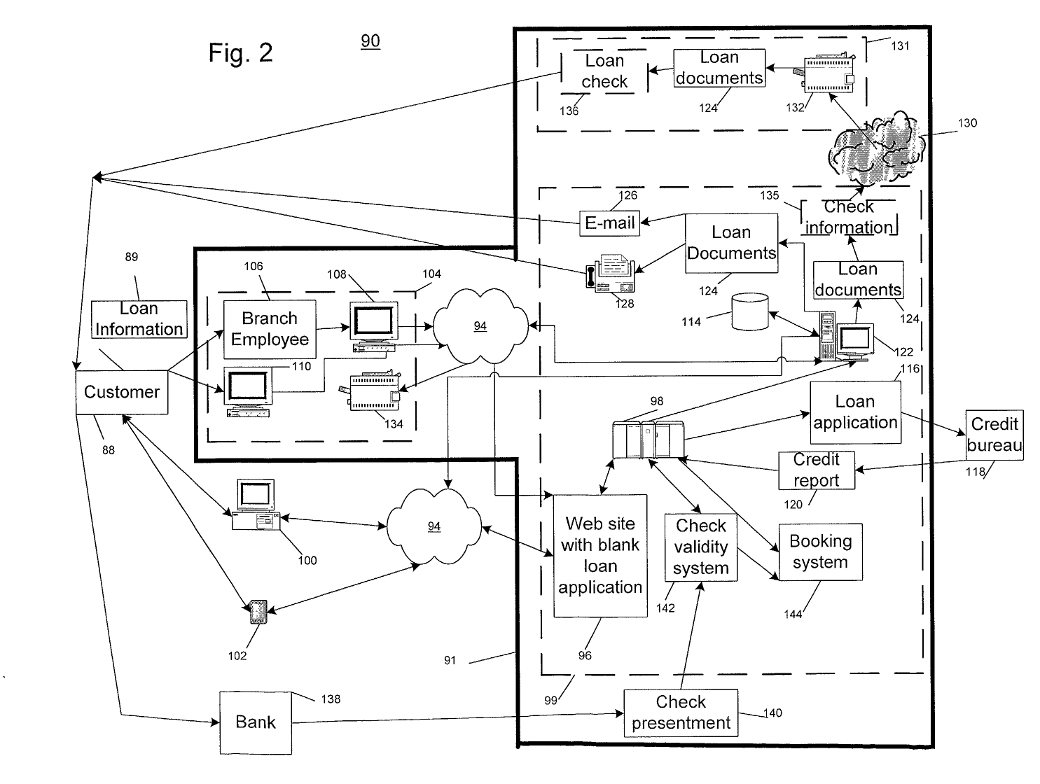

Referring to FIG. 2, there is shown a loan creation and origination system 90 in accordance with the invention. Loan origination system 90 streamlines the processes involved in the application for and approval of a loan and thereby yields a more efficient, less costly, loan origination system than the prior art. A customer 88, who is interested in applying for a loan from a bank 91, uses a computer 100 to access a web site 96 through a network 94.

Network 94 can be, for example, the Internet. Web site 96 is hosted by a loan approval system computer 98 and prompts customer 88 to enter loan information 89 in a user-friendly format. Unlike prior art systems, web site 96 includes loan application forms which are used by all who access web site 96. In one embodiment, a single standard form is used for all loan applications. Loan approval system computer 98 is typically located in a back office 99 of bank 91 that is used to process loan applications.

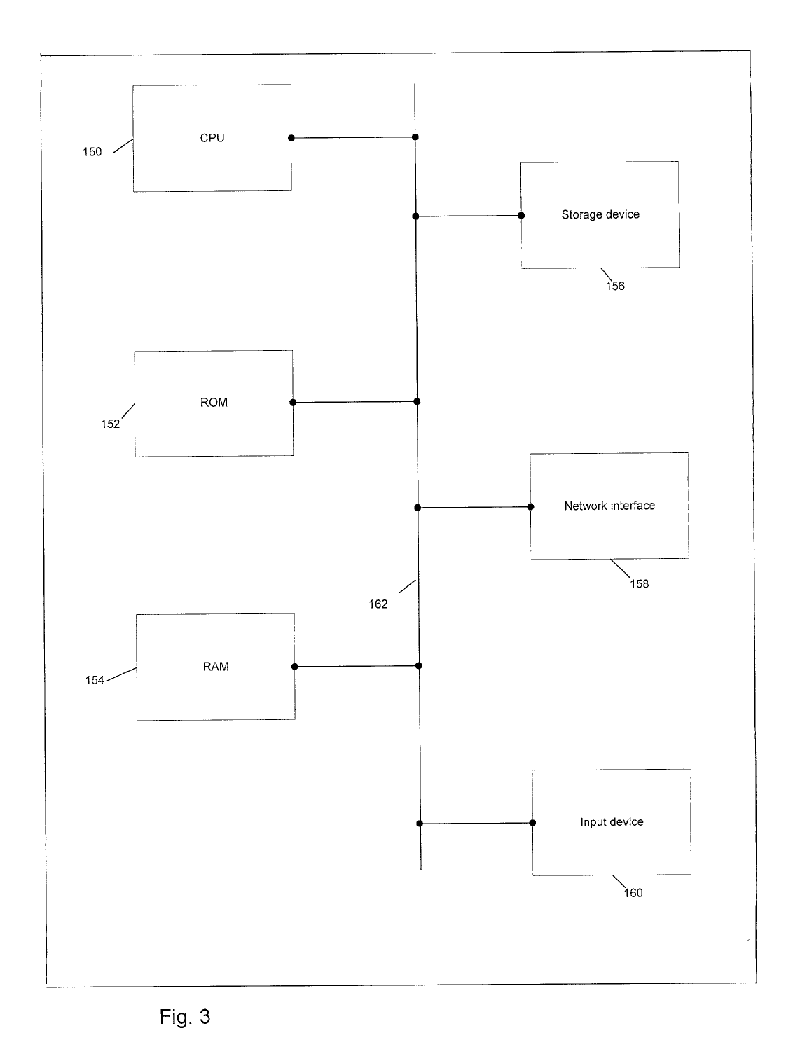

Computer 98 could be any computer device capable of providing web page HTML (hypertext mark-up language), Java, XML (extensive mark-up language), VBScript, or Jscript data and can be programmed using any conventional language including C++, Visual Basic, etc. Referring momentarily to FIG. 3, one embodiment of loan approval system computer 98 comprises a CPU 150, a ROM 152, a RAM 154, a storage device 156, a network interface 158 and an input device 160 all coupled to one another through a bus 162. Other configurations of loan approval system computer 98 are known to those skilled in the art.

Referring again to FIG. 2, customer 88 could also send loan information 89 through network 94 by accessing a personal digital assistant (“PDA”) 102 or through any other known device for accessing and sending information over a network. Network 94 can be, for example, the Internet.

As an alternative to accessing loan approval system computer 98 through network 94, customer 88 has the option of visiting a branch 104 of bank 91. At branch 104, customer 88 may visit with a branch employee 106 as in prior art loan origination systems. However, in loan origination system 90, branch employee 106 directly enters loan information 89 into a loan terminal 108 and then forwards loan information 89 over network 94 connected to loan approval system computer 98. Branch employee 106 does not need to determine which forms are needed for the customer's particular loan application because these forms will be determined by the back office as is explained in more detail below.

Customer 88 also has the option of visiting branch 104 and using a loan application kiosk 110 coupled to network 94 and web site 96. Loan application kiosk 110 prompts customer 88 to enter loan information 89 and then forwards loan information 89 through network 94 to loan approval system computer 98.

When loan information 89 is received by loan approval system computer 98, loan information 89 is analyzed for completeness. If loan information 89 is incomplete, loan approval system computer 98 sends a prompt to customer 88 requesting farther information via an interactive Internet connection. As all loan form are located at web site 96, once loan information 89 is entered into web site 96, a loan application 116 can be quickly and automatically generated. Thus, unlike prior art arrangements, it is not necessary for a branch employee to determine the correct form to be used for loan application 116.

Thereafter, loan approval system computer 98 forwards loan application 116 to a credit agency or bureau 118 (hereinafter collectively referred to as “bureau”) through, for example, web entry middleware connectivity software such as IBM MQ SERIES software or through a Transfer Connect Protocol/Internet Protocol (“TCP/IP”) connection. Bureau 118 analyzes loan application 116 and determines the credit-worthiness of customer 88 for the loan described therein. For example, bureau 118 includes a loan decisioning calculator which determines whether customer 88 has enough income to pay for the desired loan in light of other monthly expenses. Bureau 118 then sends a credit report 120 to loan approval system computer 98.

In response to credit report 120 approving loan application 116, loan approval system computer 98 sends loan application 116 to a loan document creation server 122. Loan document creation server 122 can be, for example the LOAN ORIGINATION DOCUMENT EXPRESS system owned by CHASE MANHATTAN BANK, or other similar document originating system. Loan document creation server 122 refers to a forms database 114 to produce loan documents 124 related to approved loan application 116. Loan documents 124 include a loan contract created between customer 88 and bank 91, credit insurance information regarding the loan, an approval letter, promissory note, any required attachments, and the terms of this loan contract as was indicated by customer 88 in loan information 89. Loan documents 124 are sent by loan document creation server 122 to customer 88, through any known means. For example, loan document creation server 122 may send loan documents 124 via an e-mail 126, by facsimile 128, or via network 94 if secured data capability and appropriate privacy controls are in place.

Loan document creation server 122 may also send information corresponding to loan documents 124 over a network 130 to a printer 132 located in another area 131 of bank 91 that specializes in forwarding documents to customers. This connection to printer 132 may be through Transfer Connect Protocol/Internet Protocol (“TCP/IP”) connectivity and may be used to send information corresponding to loan documents 124 to any printer coupled to network 130. Loan document creation server 122 may optionally also send check information 135 to printer 132 so that a loan check 136 associated with loan documents 124 can also be sent to customer 88. Alternatively, loan document creation server 122 may forward finds associated with loan check 136 directly to a verified demand deposit, savings, or investment account of customer 88. Such forwarding may be performed by first verifying if the customer's account is valid by sending the customer a “dummy” transaction such as a PreNote via the Federal Automated Clearing House (ACH) several days before the funds are actually deposited.

Network 130 may be a wide area network intranet, the Internet, or any other network. Loan document creation server 122 may also send loan documents 124 through network 94 back to branch 104 and to a printer 134. In this way, customer 88 may go back to branch 104 (or wait at branch 104 after requesting the loan) and pick up loan documents 124 in the same branch 104 as where customer 88 applied for the loan. Customer 88 could also designate a different branch to pick up loan documents 124.

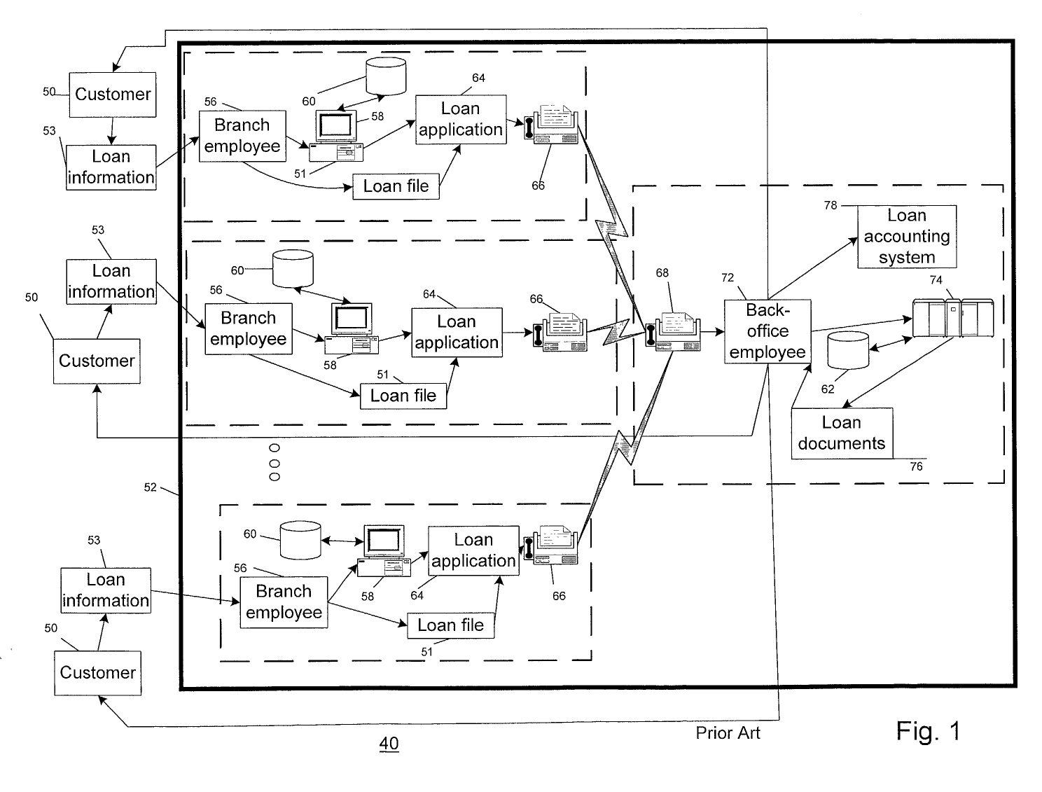

As loan origination and creation system 90 is an automated system as compared to the systems of the prior art, the application, approval, and booking processes occur much more quickly. For example, customer 88 may apply for a loan in branch 104 and receive loan documents from printer 134 within minutes of the application. Customer 88 may apply for a loan through network 94 and receive loan documents 124 via e-mail 126, fax 128, or posted on the customer's own web site, also within minutes of filing the application. This is in contrast to prior art loan origination systems (as shown in FIG. 1) which required time for branch employee 56 to produce loan application 64, time for back office employee 72 to review many applications received via fax machine 68 and enter the loan information into loan approval system mainframe 74, and time for loan documents 76 to be sent by mail to customer 50.

Referring again to FIG. 2, the invention also streamlines the acceptance by customer 88 of the loan. In an embodiment of the invention, for a typical non-complex loan, customer 88 agrees beforehand (i.e. when customer 88 enters loan information 89) that negotiating loan check 136 in a bank 138 where customer 88 has an account, is also acceptance of the loan terms in loan documents 124. Bank 138 then presents loan check 136 to a check presentment portion 140 of bank 91. Check presentment portion 140 sends loan check 136 to a check validity system 142 that reviews loan check 136 to ensure that it is a valid instrument (e.g. not a forgery). If loan check 136 is valid, check validity system 142 sends a notification to loan approval system computer 98 which notifies a booking system 144 that sets up the accounts receivable procedures involved in processing the loan requested by customer 88. Alternatively, check validity system 142 may send a notification directly to booking system 144. In more complex loans (e.g., those involving CDs, pledging, security agreements, etc.), customer 88 will review loan documents 124 and acceptance of the terms of the loan occurs when customer 88 signs these documents. Once loan documents 124 are signed by customer 88, the documents are forwarded to loan approval system computer 98 and then a notification is sent to booking system 144.

Thus, unlike prior art loan origination systems where at least two bank employees are needed to process a loan application, the invention is capable of connecting a customer directly to an approval system through a network. Alternatively, the invention may employ a single bank employee to enter the loan information into the loan origination system. In either case (connection via network or bank employee), the loan documents are created automatically and thus require less manual intensive labor than loan origination systems of the prior art. For example, even when one bank employee is used, the employee need only be skilled in data entry and not complex loan origination interfaces as in the prior art. The prior art loan origination system was thus more costly in that more skilled bank employees were necessary and these bank employees needed to be trained to interact with loan origination interfaces.

Furthermore, unlike prior art loan origination systems, the forms used in generating a loan application, in accordance with the invention, are centralized in a single location at web site 96 hosted by system computer 98. This eliminates the errors produced by bank employees grabbing or designating an incorrect loan form. Additionally, the insurance information related to each loan (which generally differs for each state) is also stored in a single database. Again, storing insurance information in a centralized database avoids errors produced in applying the incorrect insurance. A comprehensive loan calculator including annual percentage rate, insurance premium, and loan payment calculations ensures that the loan applications are in compliance with appropriate banking regulations and federal disclosure policies.

Moreover, when the loan application and document forms are to be updated, a bank employee need only update a single central location in back office 99 to update the forms. Changes can even be made to loan origination system 90 without the need to send out a technician to every branch 104 of bank 91 to update the computers coupled to back office 99. As prior art systems produced loan applications in the branch offices themselves, an update in the loan origination system may require that a technician visit every branch office to ensure that the hardware in the branch offices can handle the update.

By centralizing the loan documents in a single location, the documents can be available in a standard word processing technology format (e.g. MICROSOFT WORD). This avoids the need to procure the services of an outside vendor to handle the loan documents as was common in prior art systems. Changes can be quickly and easily made to existing loan documents through typical word processing formats, again without the need to contact an outside vendor. As the documents are controlled by bank 91, automatic backup and disaster recovery relief systems can also be implemented. These advantages all increase the speed in which documents can be changed, increase the speed in which documents can be produced, and decrease the costs in changing documents.

While preferred embodiments of the invention have been disclosed, various modes of carrying out the principles disclosed herein are contemplated as being within the scope of the following claims. Therefore, it is understood that the scope of the invention is not to be limited except as otherwise set forth in the claims.

What is claimed is:

1. A system for producing and sending a loan document to a customer, the system comprising:
a web-enabled customer interface which receives loan information from the customer;
a network coupled to the customer interface, the network receives the loan information from the customer interface;
a web site coupled to the network, the web site receives the loan information and merges the loan information with a loan application form to produce a loan application;
a loan processor, coupled to the web site, the loan processor receives the loan application, performs a credit check on the customer based on the loan application, and determines whether the customer should receive a loan based on the credit check; and a document server coupled to the loan processor, the document server generates and sends the loan document to the customer, based on the loan application, when the loan processor determines that the customer should receive the loan, the loan processor sends the loan document to the customer through one of e-mail, facsimile, the network, a first printer coupled to the network, and a second printer coupled to another network

2. The system as recited in claim 1, farther comprising:
a credit approval agency coupled to the loan processor; wherein
the loan processor performs the credit check by sending the loan application to the credit approval agency.

3. The system as recited in claim 1, wherein:
the network is the Internet; and
the customer interface is one of a computer, a personal digital assistant, and a loan application kiosk.

4. The system as recited in claim 1, wherein the loan document includes at least one of a check and data relating to an electronic transfer of funds relating to the loan.

5. The system as recited in claim 1, wherein the loan document includes insurance information relating to the loan.

6. A method for producing and sending a loan document to a customer, the loan document detailing terms of a loan, the method comprising:
receiving loan information from the customer over a network by a website;
merging the loan information with a loan application form to produce a loan application;
performing a credit check on the customer based upon the loan application;
determining whether the customer should receive the loan based on the credit check; and
when the processing determines that the customer should receive the loan, sending the customer a loan document associated with the loan, the sending being through one of e-mail, facsimile, the network, a first printer coupled to the network, and a second printed coupled to another network.

7. A method for creating a loan contract between a customer and a bank, the loan contract including terms where the bank loans money to the customer, and terms where the customer is obligated to pay the money back to the bank, the method comprising:
the bank performing the steps of:
receiving loan information from the customer, the loan information indicating the terms;
processing the loan information to determine whether the bank desires to enter into the loan contract; and
if the bank desires to enter into the loan contract:
sending a loan document to the customer, the loan document being associated with the loan contract and listing the terms; and
sending a check to the customer, the check corresponding to the loan contract;
thereafter, the customer performing the steps of:
receiving the loan document;
receiving the check; and
negotiating the check;
whereby the cashing the check indicates acceptance by the customer of the terms listed in the loan document.

8. The method as recited in claim 7, wherein:
the receiving the loan information includes merging the loan information with a loan form to produce a loan application; and
the processing the loan information comprises sending the loan application to a credit approval agency.

9. The method as recited in claim 7, wherein the receiving loan information includes receiving the loan information over a network.

10. The method as recited in claim 9, wherein:
the network is the Internet; and
the receiving loan information includes receiving loan information from the customer through one of a computer, a personal digital assistant, and a loan application kiosk.

11. The method as recited in claim 9, wherein the sending the loan document includes sending the loan document to the customer through one of e-mail, facsimile, the network, a first printer coupled to the network, another network, and a second printer coupled to the another network.

12. The method as recited in claim 7, wherein the sending the loan document includes sending the loan document to the customer through one of e-mail, facsimile, a network, and a printer coupled to the network.

13. The method as recited in claim 7, wherein the bank further performs the step of analyzing the check to determine whether the check is valid.
